(19) United States
(12) Patent Application Publication
(10) Pub. No.: US 2025/0045030 A1
(43) Pub. Date: Feb. 6, 2025

(54) METHOD, APPARATUS AND DEVICE FOR IMPLEMENTING DEPENDENCY INJECTION BASED ON HILT

(71) Applicant: BEIJING BYTEDANCE NETWORK TECHNOLOGY CO., LTD., Beijing (CN)

(72) Inventor: Xinqi Xie, Beijing (CN)

(21) Appl. No.: 18/718,357

(22) PCT Filed: Dec. 1, 2022
(86) PCT No.: PCT/CN2022/135862

§ 371 Date: Jun. 10, 2024

(30) Foreign Application Priority Data
Dec. 10, 2021 (CN) 202111508866.X

(51) Int. Cl. G06F 8/41; G06F 8/20

(52) U.S. Cl. CPC G06F 8/447; G06F 8/24

(57) ABSTRACT

The present application discloses a method for implementing dependency injection based on Hilt, for third-party components that require dependency injection, i.e., target components. After obtaining the target component, a generator corresponding to the target component is generated, and a parent class corresponding to the target component is generated with the generator, to declare a dependent object in the parent class. At the same time, an injection container and injection code corresponding to the target component are created, the target component and the dependency provider are bridged based on the injection container, and the instance of the dependency object provided by the dependency provider is assigned to the target component based on the injection code, so that when the target component is executed, the instance of the dependent object is assigned to the target component with the injection container and injection code. Finally, the target component is controlled to inherit the parent class, so that the target component inherits the dependency injection capability of the parent class, and completes the configuration of the target component to implement dependency injection, so that the target component can obtain instances of dependent objects and implement dependency injection.

### CROSS-REFERENCE

This application claims priority to Chinese Patent Application with application number 202111508866.X, filed on Dec. 10, 2021, and entitled “METHOD, APPARATUS AND DEVICE FOR IMPLEMENTING DEPENDENCY INJECTION BASED ON HILT”, which is incorporated herein by reference in its entirety.

### FIELD

The present application relates to the field of computer processing technology, and specifically relates to method, apparatus and device for implementing dependency injection based on Hilt.

### BACKGROUND

Dependency injection is the internal class being instantiated externally, without the need to do the instantiating work in the internal class, and instead, it is left to the external container to complete, and finally injected into the caller, forming dependency injection. Where Hilt is dependency injection library of Android, and during the Android application development process, it supports dependency injection of Android native components. Where components are simple encapsulation of data and methods, configured to implement specific functions.

However, for third-party components developed by developers themselves, Hilt does not support the use of dependency injection on such components, causing the third-party components to be instantiated, and affecting the work efficiency of the third-party components.

### SUMMARY

In view of this, the present application provides a method, device and apparatus for implementing dependency injection based on Hilt, so that third-party components can implement dependency injection based on Hilt and improve the work efficiency of third-party components.

In order to achieve the above purpose, the technical solutions provided by the embodiments of this application are as follows:

In a first aspect of the present application, a method for implementing dependency injection based on Hilt is provided. The method comprises:
Obtaining a target component, the target component is a non-native component in an Android application;
In response to the target component requiring dependency injection, creating a generator corresponding to the target component;
Generating, with the generator, a parent class of the target component to declare a dependent object in the parent class;
Creating an injection container and injection code corresponding to the target component, the injection container being configured to bridge the target component and a dependency provider, and the injection code being configured to assign an instance of a dependency object provided by the dependency provider to the target component; and;
Controlling the target component to inherit the parent class.

In a second aspect of the present application, an apparatus for implementing dependency injection based on Hilt is provided, the apparatus comprises:
An obtaining unit configured to obtain a target component, and the target component is not a native component in an Android application;
A first creating unit configured to create a generator corresponding to the target component in response to the target component requiring dependency injection;
A generating unit configured to generate, with the generator, a parent class of the target component to declare a dependent object in the parent class;
A second creating unit configured to create an injection container and injection code corresponding to the target component, the injection container being configured to bridge the target component and a dependency provider, and the injection code being configured to assign an instance of a dependency object provided by the dependency provider to the target component; and
A control unit configured to control the target component to inherit the parent class.

In a third aspect of the present application, an electronic device is provided, the device comprising: a processor and a memory;
The memory being configured to store instructions or computer programs;
The processor being configured to execute the instructions or the computer program in the memory to cause the electronic device to implement the method of the first aspect.

In a fourth aspect of the present application, a computer-readable storage medium, comprising instructions which, when run on a computer, cause the computer to implement the method of the first aspect above.

It can be seen that the embodiments of the present application have the following beneficial effects:

The technical solution provided by embodiments of the present application is aimed at third-party components that require dependency injection, i.e., target components. After obtaining a target component, creating a generator corresponding to the target component, and generating, with the generator, a parent class corresponding to the target component to declare a dependent object in the parent class. At the same time, creating an injection container and injection code corresponding to the target component, bridging the target component and a dependency provider based on the injection container, and assigning an instance of a dependency object provided by the dependency provider to the target component based on the injection code, so that when the target component is executed, the instance of the dependent object is assigned to the target component with the injection container and injection code. Finally, controlling the target component to inherit the parent class, so that the target component inherits the dependency injection capability of the parent class, and completes the configuration of the target component to implement dependency injection, thereby the target component can obtain instances of dependent objects and implement dependency injection.

### BRIEF DESCRIPTION OF THE DRAWINGS

FIG. 1 is a flow chart of a method for implementing dependency injection based on Hilt provided by embodiments of the present application;

FIG. 2a is a compilation pictorial diagram provided by embodiments of the present application;

FIG. 2b is another pictorial compilation diagram provided by embodiments of the present application;

FIG. 3 is a structure diagram of an apparatus for implementing dependency injection based on Hilt provided by embodiments of the present application;

FIG. 4 is a structural diagram of an electronic device provided by embodiments of the present application.

### DETAILED DESCRIPTION

In order to make the above purposes, features and advantages of the present application more obvious and easy to understand, the embodiments of the present application will be further described in detail below with reference to the accompanying drawings and detailed embodiments. It would be appreciated that the specific embodiments described here are only used to explain the present application and are not intended to limit the present application. In addition, it should be noted that, for convenience of description, only the parts related to the present application are shown in the drawings, not all structures.

For ease of understanding the technical solution of the present application, the technical terms involved in the present application will be explained below.

The so-called dependency injection means that during the process of the program is running, if calling another object for assistance in needed, creating the callee in the code in not needed, but rely on external injection. Hilt is a dependency injection library of Android, which reduces manual dependencies in projects and saves a lot of time for Android developers. Specifically, Hilt creates a standard set of components and scopes, and these components are automatically integrated into the life cycle of Android applications. The scope of use can be declared when using to only use in the specified scope. And Hilt can provide lifecycle management, automatically release objects that are not in the scope of use, reducing excessive use of resources, and provide code reusability.

Where object corresponds to the static attributes and dynamic attributes of things with attributes and methods. Class is an abstract concept configured to describe objects of the same type. A class is an abstraction of a set of objects having common attribute names and behaviors, while an object is a real instance of a class. Component is also an abstract concept, can be understood as a combination of classes that conform to certain specifications to form a component, which can provide certain specific functions.

Where components that Hilt supports dependency injection can include Application, Activity, Fragment, View, Service, BroadcastReceiver, etc. Where the Application component is declared by using the @HiltAndroidApp annotation, and other components are declared by using the @AndroidEntryPoint annotation.

Where @HiltAndroidApp will trigger code generation of Hilt as the base class of the program dependency container. The generated Hilt is attached to the life cycle of Application, which is the parent component of the application and provides dependencies to access other components. After configuring in Application, then the components provided by Hilt can be used. @HiltAndroidApp can also create a dependency container that follows life cycle classes of Android. Current supported types are: Activity, Fragment, View, Service, etc.

@Inject is configured to tell Hilt how to provide instances of this class, often used in constructor methods, non-private fields, and methods. Hilt also calls information about how to provide instances of different types to be bindings.

@Module can be configured to create third-party dependent objects. For classes annotated with @Module, using the @InstallIn annotation to specify the scope of the module is needed. Where increasing the class of the @Module annotation actually represents a module, and tell in which container the binding installation can be used with the specified component.

@InstallIn, is configured to use classes injected by using @Module, the @InstallIn annotation to specify the scope of the module is needed. For example, a module annotated with @InstallIn(ActivityComponent::class) will be bound to the life cycle of the activity.

@Provides is often configured on internal methods of classes marked with @Module annotations and provides dependency objects.

@EntryPoint, because Hilt supports dependency injection of the most common Android classes Application, Activity, Fragment, View, Service, BroadcastReceiver, etc., but in some application scenarios, performing dependency injection in classes that Hilt does not support may be needed, in this case the @EntryPoint annotation can be used to create, and Hilt will provide the corresponding dependencies.

Inheritance is a major feature of object-oriented, and there have to be two to implement inheritance: parent class, the inherited class, which can also be called base class and super class; subclass, the class that inherits other classes, is called a subclass, also known as derived class. Features: the subclass object has all the attributes of the parent class object, and can access or even modify the process of the parent class method.

In order to enable the use of Hilt in third-party components to achieve the same dependency injection effect as native components, this application embodiments provides a method to implement dependency injection based on Hilt. For third-party components, first obtain the component by scanning, i.e., the target component. Create a generator for the target component, and generate, with the generator, a parent class corresponding to the target component to declare a dependent object in the parent class. At the same time, create an injection container and injection code corresponding to the target component, the injection container is configured to bridge the target component and a dependency provider, and the injection code is configured to assign an instance of a dependency object provided by the dependency provider to the target component. In addition, control the target component to inherit the parent class, so that when the target component is running, dependency declaration and injection are completed with the methods in the inherited parent class, to improve the work efficiency of third-party components.

For ease of understanding, the method provided by embodiments of this application will be explained below with reference to the accompanying drawings.

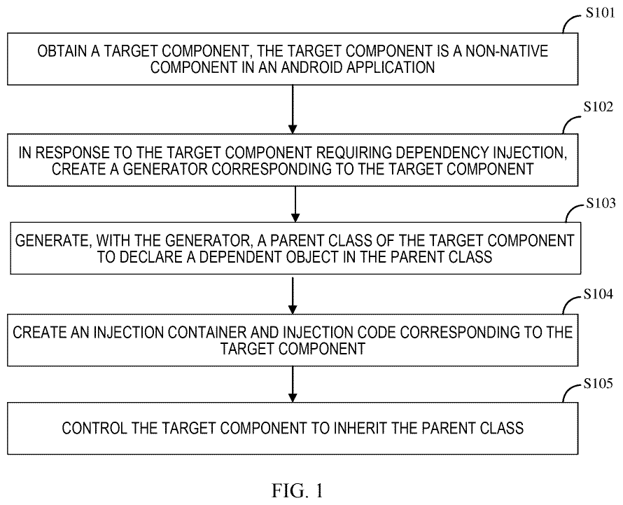

Reference is made to FIG. 1, which is a flow chart of a dependency injection method based on Hilt provided by embodiments of the present application. As shown in FIG. 1, the method may include:

S101: obtain a target component.

In this embodiment, in order to implement dependency injection of third-party components, firstly obtain the third-party component, i.e., the target component. Wherein, the target component is a non-native component in an Android application. Specifically, whether the current class source code file is a non-native component can be determined by scanning the class source code file, and when the current class source code file is a non-native component, obtain the current class source code file (target component).

S102: In response to the target component requiring dependency injection, create a generator corresponding to the target component.

In this embodiment, after obtaining the target component, whether the target component requires dependency injection can also be further determined. If requires, create a generator corresponding to the target component. Wherein, whether requiring dependency injection can be determined by determining whether it has dependency annotations in the target component. If it has dependency annotations, it indicates that the target component requires dependency injection, and a generator is created. Wherein, the dependency annotation can be the @AndroidEntryPoint annotation, the annotation is configured to provide class dependencies, that is, representing that this class will be used in the injected instance.

S103: Generate, with the generator, a parent class of the target component to declare a dependent object in the parent class.

After creating the generator corresponding to the target component, generate a parent class of the target component with the generator to declare a dependent object in the parent class.

Specifically, after generating the parent class, a first method can also be generated in the parent class, and the first method is a life cycle callback method. That is, the life cycle of the dependent object is defined with the first method. Wherein, the first method may be the onCreate method. At the same time, the third method can also be called in the first method, and the third method is configured to assign values for dependent objects. Wherein, the third method is the inject method.

In addition, considering that the target component depends on different types of objects, in order to satisfy the types of objects it depends on as quickly as possible, a second method can also be generated in the parent class, and the second method is the method of obtaining ViewMdelFactory object. Specifically, in the second method, the pre-injected ViewModelFactory is returned by calling Hilt.API to generate a ViewModel object.

S104: Create an injection container and injection code corresponding to the target component.

In this embodiments, create the injection container and injection code of the target component, to bridge the target component and the dependency provider with the injection container, and then, when the target component is run, the instance of the dependency object provided by the dependency provider is injected into the target with the injection code.

In addition, after obtaining the injection container and injection code, aggregate the injection container and injection code into the Application implementation class in each application to generate a directed acyclic graph of dependencies in the Application implementation class to check Whether all the dependency providers match dependency demanders. If not match, an error will be reported during the compilation phase, so that developers can check whether the way to use the dependency injection framework is correct. In response to all dependency providers matching dependency demanders, the application starting and the target component running, dependency injection can be achieved by using the injection container and injection codes match and when.

S105: Control the target component to inherit the parent class.

Due to the execution code of dependency injection is generated in the parent class, it is necessary to control the target component to inherit the parent class and then inherit the capability of dependency injection.

Wherein, controlling the target component to inherit the parent class can be achieved by the following ways. Specifically, obtain the Class file corresponding to the parent class, so that the target component inherits the parent class by modifying the Class file and the inheritance chain of the target component.

In addition, in actual applications, the inheritance relationship between the target component and the native component can be configured, so that when implementing dependency injection, the subclass can inherit the dependency injection capability of the parent class and obtain an instance of the dependent object. For example, the target component is the parent class and the native component is the subclass; or the native component is the parent class and the target component is the subclass.

It can be seen, for third-party components, the component can be obtained by scanning firstly, i.e., the target component. Create a generator for the target component to generate the parent class corresponding to the target component with the generator, so that the dependent objects can be declared in the parent class. At the same time, create an injection container and injection code corresponding to the target component. The injection container is configured to bridge the target component and the dependency provider method, and the injection code is configured to assign the instance of the dependency object provided by the dependency provider method to the target component. In addition, control the target component to inherit the parent class, so that when the target component is running, dependency declaration and injection are completed with the methods in the inherited parent class, thereby improving the work efficiency of third-party components.

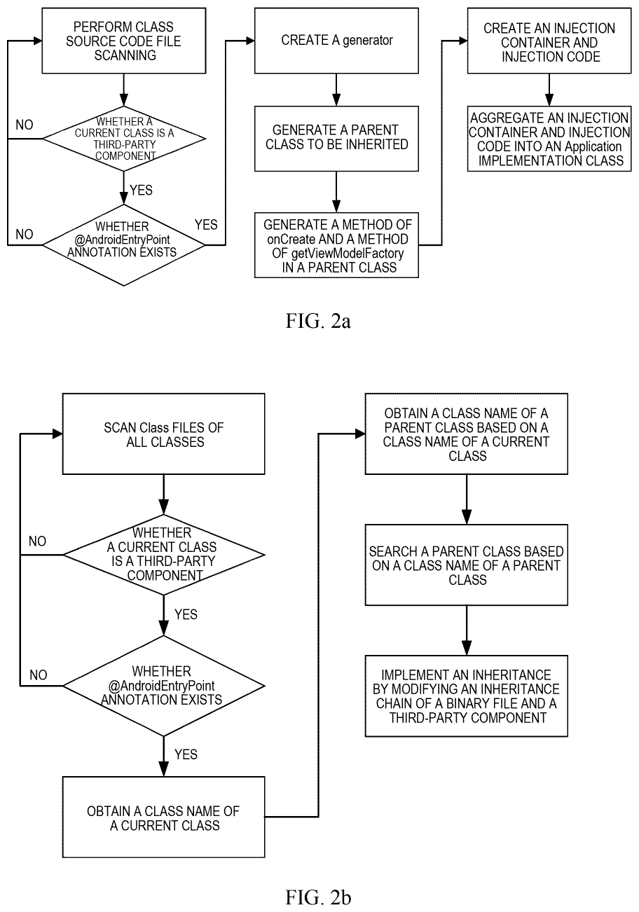

For the ease of understanding the embodiments of this application, reference is made to the processing framework shown in FIG. 2a and FIG. 2b, where the processing processes shown in FIG. 2a and FIG. 2b both belong to the compilation stage. FIGS. 2a and 2b will be explain below respectively.

Referring to FIG. 2a, after entering the compilation stage, source code file scanning is performed. During the scanning process, when a certain type of source code file is scanned, whether the source code file of this type is a third-party component is determined. If not, the scan continues until scanning to a third-party component. Where, the Annotation Processor Tool (APT) can be used to perform scanning operations. APT is a tool used in javac to scan and process annotations while compiling. The annotation processor can generate Java code, and the generated Java code will be composed into .java files.

After determining the third-party component, determine whether there is an @AndroidEntryPoint annotation in the source code file. If so, it represents that the third-party component requires dependency injection, and then create a generator corresponding to the third-party component. Generate the parent class that the third-party components need to inherit with the generator, and generate the onCreate method and getViewModelFactory method in the parent class (this method is selected to generate based on actual needs). At the same time, the inject method is called in the onCreate method to complete the assignment of dependent objects with the inject method. Where, the getViewModelFactory method returns the pre-injected ViewModelFactory by calling Hilt.API to generate a ViewModel object.

After generating the parent class, create the injection container and injection code corresponding to the third-party component, and aggregate the injection container and injection code into the third-party component implementation class.

After the first compilation in FIG. 2a, the .Java file is compiled into a Class file and enters the second compilation shown in FIG. 2b. Scan the Class files of all classes and determine whether the current scanned Class file is a third-party component. If not, continue scanning until scanning to a third-party component.

Determine whether the third-party component exists the @AndroidEntryPoint annotation. If it exists, it represents that the third-party component is a dependent object demander, and obtain the class name of the current class. Obtain the class name of the parent class based on the class name, and then search the parent class generated in the previous stage based on the class name of the parent class, so that the third-party component can directly inherit the parent class by modifying an inheritance chain of the binary file and the third-party component, thereby, allowing third-party components to inherit dependency injection capabilities. Where, the naming rule of the class name of the parent class can be: the package name of the class+“.Hilt_”+ the class name of the current class.

Based on the above method embodiments, the embodiments of this application provide a device and electronic apparatus for implementing dependency injection based on Hilt, which will be explained below with reference to the accompanying drawings.

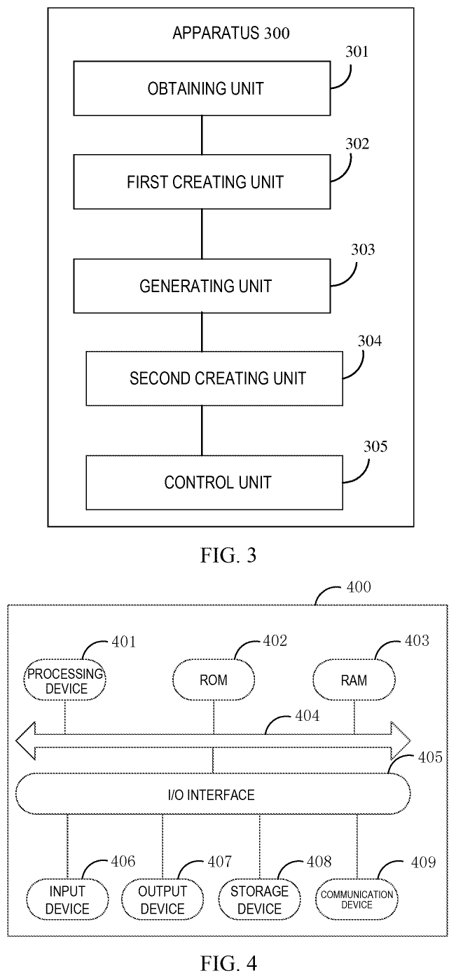

Reference is made to FIG. 3, which is a structural diagram of an apparatus for implementing dependency injection based on Hilt provided by embodiments of the present application. As shown in FIG. 3, the apparatus 300 may include: an obtaining unit 301, a first creating unit 302, a generating unit 303, the second creating unit 304 and a control unit 305.

An obtaining unit 301 configured to obtain a target component, and the target component is not a native component in an Android application;

A first creating unit 302 configured to create a generator corresponding to the target component in response to the target component requiring dependency injection;

A generating unit 303 configured to generate, with the generator, a parent class of the target component to declare a dependent object in the parent class;

A second creating unit 304 configured to create an injection container and injection code corresponding to the target component, the injection container being configured to bridge the target component and a dependency provider, and the injection code being configured to assign an instance of a dependency object provided by the dependency provider to the target component; and

A control unit 305 configured to control the target component to inherit the parent class.

In a specific implementation, the obtaining unit 301 is specifically configured to perform class source code file scanning to determine whether the current class source code file is a non-native component; when the current class source code file is a non-native component, obtain the class source code files.

In a specific implementation, the first creating unit 302 is specifically configured to create a generator corresponding to the target component when the target component exists dependency injection.

In a specific implementation, the generating unit 303 is further configured to generate a first method in the parent class after generating the parent class of the target component, and the first method is a life cycle callback method.

In a specific implementation, the generating unit 303 is further configured to generate a second method in the parent class, and the second method is a method of obtaining a ViewModelFactory object.

In a specific implementation, the apparatus further comprises: a invoking unit;

The invoking unit is configured to invoke a third method in the first method, the third method being configured to assign a value to a dependent object.

In a specific implementation, the control unit 305 is specifically configured to obtain the Class file corresponding to the parent class; by modifying the inheritance chain of the Class file and the target component, cause the target component to inherit all the parent class.

It should be noted that the implementation of each unit in this embodiment can refer to the above method embodiments, and this embodiment will not be described in details here.

Reference is made to FIG. 4 in the following, which shows a schematic diagram of an electronic device (a terminal device or a server) 400 according to an embodiment of the present disclosure. Terminal devices in the embodiments of this application may include, but are not limited to, mobile phones, notebook computers, digital broadcast receivers, PDA (Personal Digital Assistant, personal digital assistant), PAD (portable android device, tablet computer), PMP (Portable Media Player, portable multimedia players), vehicle-mounted terminals (such as vehicle-mounted navigation terminals), etc., as well as fixed terminals such as digital TV (television, television), desktop computers, etc. The electronic device shown in FIG. 4 is only an example, and should not limit the function and application range of the embodiments of the present disclosure.

As shown in FIG. 4, the electronic device 400 may include a processing device (such as a central processing unit, a graphics processing unit, or the like) 401 that may perform various appropriate actions and processing according to a program stored in a read-only memory (ROM) 402 or a program loaded from a storage device 408 into a random-access memory (RAM) 403. In the RAM 403, various programs and data required for operation of the electronic device 400 are further stored. The processing device 401, the ROM 402, and the RAM 403 are connected to each other by using a bus 404. An input/output (I/O) interface 405 is also connected to the bus 404.

Generally, the following devices may be connected to the I/O interface 405: input device 406 including, for example, a touchscreen, a touchpad, a keyboard, a mouse, a camera, a microphone, an accelerometer, and a gyroscope; output device 407 including, for example, a liquid crystal display (LCD), a loudspeaker and a vibrator; storage device 408 including, for example, a tape or a hard disk; and a communications device 409. The communications device 409 may allow the electronic device 400 to communicate wirelessly or wiredly with another device to exchange data. Although FIG. 4 shows an electronic device 400 with various devices, it should be understood that it is not required to implement or provide all shown devices. Alternatively, more or fewer devices may be implemented or provided.

In particular, according to embodiments of the present application, the processes described above with reference to the flowcharts may be implemented as computer software programs. For example, embodiments of the present application include a computer program product, which includes a computer program carried on a non-transitory computer-readable medium, and the computer program includes program code used to perform the method shown in the flowchart. In such embodiments, the computer program can be downloaded and installed from the network via the communication device 409, or installed from the storage device 408, or installed from the ROM 402. When the computer program is executed by the processing device 401, the above-mentioned functions defined in the method of embodiments of the present application are executed.

The electronic apparatus provided by the embodiments of the present application belongs to the same inventive concept as the method for implementing dependency injection based on Hilt provided by the above embodiments. Technical details that are not described in detail in the embodiments can be refer to the above embodiments, and the embodiments has the same beneficial effects as the above embodiments.

The embodiments of the present application provide a computer-readable medium on which a computer program is stored. Where, when the program is executed by a processor, the method for implementing dependency injection based on Hilt as described in any of the above embodiments is implemented.

It should be noted that the foregoing computer-readable medium in the present application may be a computer-readable signal medium, a computer-readable storage medium, or any combination of the two. The computer-readable storage medium may be, for example, an electrical, magnetic, optical, electromagnetic, infrared, or semiconductor system, apparatus, or means, or any combination thereof.

More specific examples of the computer-readable storage medium may include but are not limited to: an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present application, the computer-readable storage medium may be any tangible medium that includes or stores a program, and the program may be used by or in combination with an instruction execution system, apparatus, or means. In the present application, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any computer-readable medium other than the computer-readable storage medium, and the computer-readable signal medium may send, propagate, or transmit a program that is used by or in combination with an instruction execution system, apparatus, or means. The program code included in the computer-readable medium may be transmitted by using any suitable medium, including but not limited to: a wire, an optical cable, a radio frequency (RF), or any suitable combination thereof.

In some embodiments, the client and the server can communicate by using any currently known or future-developed network protocol, for example, an HTTP (Hyper Text Transfer Protocol), and can be interconnected by a communication network of any form or any medium. Examples of the communication network include a local area network (“LAN”), a wide area network (“WAN”), an internet network (for example, the Internet), and an end-to-end network (for example, an ad hoc end-to-end network), and any currently known or future-developed network.

The foregoing computer-readable medium may be included in the foregoing electronic device; it may also exist separately without being assembled into the electronic device.

The foregoing computer-readable medium carries one or more programs.

When the foregoing one or more programs are executed by the electronic device, the electronic device executes the foregoing method for implementing dependency injection based on Hilt.

Computer program codes for performing the operations of the present disclosure may be written in one or more programming languages or a combination thereof, such as object-oriented programming languages Java, Smalltalk, C++, and conventional procedural programming languages such as “C” or similar program design languages. The program codes may be executed completely on a user computer, partially on a user computer, as an independent package, partially on a user computer and partially on a remote computer, or completely on a remote computer or server. In cases involving a remote computer, the remote computer may be connected to a user computer through any type of network, including a local area network (LAN) or a wide area network (WAN), or may be connected to an external computer (for example, through the Internet by using an Internet service provider).

Flowcharts and block diagrams in the accompanying drawings illustrate possible architectures, functions, and operations of systems, methods, and computer program products according to various embodiments of the present disclosure. In this regard, each block in a flowchart or block diagram may represent a module, program segment, or part of code that includes one or more executable instructions for implementing a specified logical function. It should also be noted that in some alternative implementations, functions marked in the block may also occur in different order than those marked in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

The units described in embodiments of the present disclosure may be implemented either by means of software or by means of hardware. Where, the names of these units do not limit the units themselves under certain circumstances. For example, the voice data collection module can also be described as a “data collection module”.

The functions described above herein may be performed, at least in part, by one or more hardware logic components. For example, and without limitation, exemplary types of hardware logic components that may be used include: Field Programmable Gate Arrays (FPGAs), Application Specific Integrated Circuits (ASICs), Application Specific Standard Products (ASSPs), Systems on Chips (SOCs), Complex Programmable Logical device (CPLD) and so on.

In the context of the present application, a machine-readable medium may be a tangible medium that may contain or store a program for use by or in connection with an instruction execution system, apparatus, or device. The machine-readable medium may be a machine-readable signal medium or a machine-readable storage medium. Machine-readable media may include, but are not limited to, electronic, magnetic, optical, electromagnetic, infrared, or semiconductor systems, apparatus or device, or any suitable combination of the foregoing. More specific examples of machine-readable storage media would include one or more wire-based electrical connection, portable computer disks, hard disks, random access memory (RAM), read only memory (ROM), erasable programmable read only memory (EPROM or flash memory), optical fiber, portable compact disk read-only memory (CD-ROM), optical storage device, magnetic storage device, or any suitable combination of the foregoing.

According to one or more embodiments of this application, this application provides a method for implementing dependency injection based on Hilt, comprising:
Obtaining a target component, the target component is a non-native component in an Android application;
In response to the target component requiring dependency injection, creating a generator corresponding to the target component;
Generating, with the generator, a parent class of the target component to declare a dependent object in the parent class;
Creating an injection container and injection code corresponding to the target component, the injection container being configured to bridge the target component and a dependency provider, and the injection code being configured to assign an instance of a dependency object provided by the dependency provider to the target component; and
Controlling the target component to inherit the parent class.

According to one or more embodiments of this application, in the method for implementing dependency injection based on Hilt provided by this application, obtaining a target component comprises:
Performing class source code file scanning to determine whether a current class source code file is a non-native component; and
In response to the current class source code file being a non-native component, obtaining the class source code file.

According to one or more embodiments of this application, in the method for implementing dependency injection based on Hilt provided by this application, in response to the target component requiring dependency injection, creating a generator corresponding to the target component comprises:

In response to the target component has a dependency annotation, creating a generator corresponding to the target component.

According to one or more embodiments of this application, in the method for implementing dependency injection based on Hilt provided by this application, after generating, with the generator, a parent class of the target component, the method further comprises:

Generating a first method in the parent class, the first method being a lifecycle callback method.

According to one or more embodiments of this application, in the method for implementing dependency injection based on Hilt provided by this application, the method further comprises:

Generating a second method in the parent class, the second method being a method of obtaining a ViewModelFactory object.

According to one or more embodiments of this application, in the method for implementing dependency injection based on Hilt provided by this application, the method further comprises:

Invoking a third method in the first method, the third method being configured to assign a value to a dependent object.

According to one or more embodiments of this application, in the method for implementing dependency injection based on Hilt provided by this application, controlling the target component to inherit the parent class comprises:
Obtaining a Class file corresponding to the parent class; and
Causing, by modifying an inheritance chain of the Class file and the target component, the target component to inherit the parent class.

According to one or more embodiments of this application, this application provides a apparatus for implementing dependency injection based on Hilt, comprising:
An obtaining unit configured to obtain a target component, and the target component is not a native component in an android application;
A first creating unit configured to create a generator corresponding to the target component in response to the target component requiring dependency injection;
A generating unit configured to generate, with the generator, a parent class of the target component to declare a dependent object in the parent class;
A second creating unit configured to create an injection container and injection code corresponding to the target component, the injection container being configured to bridge the target component and a dependency provider, and the injection code being configured to assign an instance of a dependency object provided by the dependency provider to the target component; and
A control unit configured to control the target component to inherit the parent class.

According to one or more embodiments of this application, in the apparatus for implementing dependency injection based on Hilt provided by this application, the obtaining unit is specifically configured to perform class source code file scanning and determine whether the current class source code file is a non-native component; when the current class source code file is a non-native component, obtain the class source code file.

According to one or more embodiments of this application, in the apparatus for implementing dependency injection based on Hilt provided by this application, the first creating unit is specifically configured to create a generator corresponding to the target component when the target component exists dependency injection.

According to one or more embodiments of this application, in the apparatus for implementing dependency injection based on Hilt provided by this application, the generating unit is further configured to generate a first method in the parent class after generating the parent class of the target component, and the first method is a life cycle callback method.

According to one or more embodiments of this application, in the apparatus for implementing dependency injection based on Hilt provided by this application, the generating unit is further configured to generate a second method in the parent class, and the second method is a method of obtaining ViewModelFactory object.

According to one or more embodiments of this application, in the apparatus for implementing dependency injection based on Hilt provided by this application, the apparatus further comprising: a invoking unit;

The invoking unit is used to invoke a third method in the first method, and the third method being configured to assign a value to a dependent object.

According to one or more embodiments of this application, in the apparatus for implementing dependency injection based on Hilt provided by this application, the control unit is specifically configured to obtain the Class file corresponding to the parent class; by modifying the inheritance chain of the Class file and the target component, cause the target component to inherit all the parent class.

It should be noted that each embodiment is described in a progressive manner in the specification. Each embodiment focuses on its differences from other embodiments. The same and similar parts between each embodiment can be referred to each other. For the system or apparatus disclosed by embodiments, since it corresponds to the method disclosed by embodiments, the description is relatively simple. For relevant details, please refer to the method description section.

It should be understood that in this application, “at least one (item)” refers to one or more, and “plurality” refers to two or more. “And/or” is used to describe the relationship between associated objects, indicating that there can be three relationships. For example, “A and/or B” can represent: only A exists, only B exists, and A and B exist simultaneously, where A and B can be singular or plural. The character “/” generally indicates that the related objects before and after are in an “or” relationship. “At least one of the following” or similar expressions thereof refers to any combination of these items, including any combination of a single item or a plurality of items. For example, at least one item of a, b or c can represent: a, b, c, “a and b”, “a and c”, “b and c”, or “a and b and c”, where a, b, c can be single or multiple.

It should also be noted that herein relational terms such as first and second are only used to distinguish one entity or operation from another entity or operation, and do not necessarily require or imply that between these entities or operations exists any such actual relationship or sequence. Furthermore, the terms “comprise” “include” or any other variations thereof are intended to cover a non-exclusive inclusion such that a process, method, item, or device that includes a list of elements not only includes those elements, but also includes other elements which are not expressly listed, or includes inherent elements of this process, method, item or device. Without further limitation, an element defined by the statement “comprises a . . . ” does not exclude the presence of additional identical elements in a process, method, item, or device that includes the stated element.

The steps of the method or algorithms described in conjunction with the embodiments disclosed herein may be implemented directly in hardware, in software modules executed by a processor, or in a combination of the two. Software modules may be located in random access memory (RAM), memory, read-only memory (ROM), electrically programmable ROM, electrically erasable programmable ROM, registers, hard disks, removable disks, CD-ROMs, or in any other form of storage media known in the field.

The above description of the disclosed embodiments enables those skilled in the art to implement or use the present application. Various modifications to these embodiments will be apparent to those skilled in the art, and the general principles defined herein may be implemented in other embodiments without departing from the spirit or scope of the application. Therefore, the present application is not to be limited to the embodiments shown herein but is to be accorded with the widest scope consistent with the principles and novel characteristic disclosed herein.

1. A method for implementing dependency injection based on Hilt, the method comprises:
obtaining a target component, the target component is a non-native component in an Android application;
in response to the target component requiring dependency injection, creating a generator corresponding to the target component;
generating, with the generator, a parent class of the target component to declare a dependent object in the parent class;
creating an injection container and injection code corresponding to the target component, the injection container being configured to bridge the target component and a dependency provider, and the injection code being configured to assign an instance of a dependency object provided by the dependency provider to the target component; and
controlling the target component to inherit the parent class.

2. The method of claim 1, wherein obtaining a target component comprises:
performing class source code file scanning to determine whether a current class source code file is a non-native component; and
in response to the current class source code file being a non-native component, obtaining the class source code file.

3. The method of claim 1, wherein in response to the target component requiring dependency injection, creating a generator corresponding to the target component comprises:
in response to the target component has a dependency annotation, creating a generator corresponding to the target component.

4. The method of claim 1, wherein after generating, with the generator, a parent class of the target component, the method further comprises:
generating a first method in the parent class, the first method being a lifecycle callback method.

5. The method of claim 4, wherein the method further comprises:
generating a second method in the parent class, the second method being a method of obtaining a ViewModelFactory object.

6. The method of claim 4, wherein the method further comprises:
invoking a third method in the first method, the third method being configured to assign a value to a dependent object.

7. The method of claim 1, wherein controlling the target component to inherit the parent class comprises:
obtaining a Class file corresponding to the parent class; and
causing, by modifying an inheritance chain of the Class file and the target component, the target component to inherit the parent class.

8. (canceled)

9. An electronic device, wherein the device comprises: a processor and a memory;
wherein the memory is configured to store instructions or computer programs;
wherein the processor is configured to execute the instructions or the computer program in the memory to cause the electronic device to implement acts comprising:
obtaining a target component, the target component is a non-native component in an Android application;
in response to the target component requiring dependency injection, creating a generator corresponding to the target component;
generating, with the generator, a parent class of the target component to declare a dependent object in the parent class;
creating an injection container and injection code corresponding to the target component, the injection container being configured to bridge the target component and a dependency provider, and the injection code being configured to assign an instance of a dependency object provided by the dependency provider to the target component; and
controlling the target component to inherit the parent class.

10. A non-transitory computer-readable storage medium, comprising instructions which, when run on a computer, cause the computer to implement acts comprising:
obtaining a target component, the target component is a non-native component in an Android application;
in response to the target component requiring dependency injection, creating a generator corresponding to the target component;
generating, with the generator, a parent class of the target component to declare a dependent object in the parent class;
creating an injection container and injection code corresponding to the target component, the injection container being configured to bridge the target component and a dependency provider, and the injection code being configured to assign an instance of a dependency object provided by the dependency provider to the target component; and
controlling the target component to inherit the parent class.

11. The device of claim 9, wherein obtaining a target component comprises:
performing class source code file scanning to determine whether a current class source code file is a non-native component; and
in response to the current class source code file being a non-native component, obtaining the class source code file.

12. The device of claim 9, wherein in response to the target component requiring dependency injection, creating a generator corresponding to the target component comprises:
in response to the target component has a dependency annotation, creating a generator corresponding to the target component.

13. The device of claim 9, wherein after generating, with the generator, a parent class of the target component, the method further comprises:
generating a first method in the parent class, the first method being a lifecycle callback method.

14. The device of claim 13, wherein the acts further comprise:
generating a second method in the parent class, the second method being a method of obtaining a ViewModelFactory object.

15. The device of claim 13, wherein the acts further comprise:
invoking a third method in the first method, the third method being configured to assign a value to a dependent object.

16. The device of claim 9, wherein controlling the target component to inherit the parent class comprises:
obtaining a Class file corresponding to the parent class; and
causing, by modifying an inheritance chain of the Class file and the target component, the target component to inherit the parent class.

17. The non-transitory computer-readable storage medium of claim 10, wherein obtaining a target component comprises:
performing class source code file scanning to determine whether a current class source code file is a non-native component; and
in response to the current class source code file being a non-native component, obtaining the class source code file.

18. The non-transitory computer-readable storage medium of claim 10, wherein in response to the target component requiring dependency injection, creating a generator corresponding to the target component comprises:
in response to the target component has a dependency annotation, creating a generator corresponding to the target component.

19. The non-transitory computer-readable storage medium of claim 10, wherein after generating, with the generator, a parent class of the target component, the method further comprises:
generating a first method in the parent class, the first method being a lifecycle callback method.

20. The non-transitory computer-readable storage medium of claim 19, wherein the acts further comprise:
generating a second method in the parent class, the second method being a method of obtaining a ViewModelFactory object.

21. The non-transitory computer-readable storage medium of claim 19, wherein the act further comprises:
invoking a third method in the first method, the third method being configured to assign a value to a dependent object.
